(19) United States
(12) Patent Application Publication
(10) Pub. No.: US 2024/0290108 A1
(43) Pub. Date: Aug. 29, 2024

(54) INFORMATION PROCESSING APPARATUS, INFORMATION PROCESSING METHOD, LEARNING APPARATUS, LEARNING METHOD, AND COMPUTER PROGRAM

(71) Applicant: SONY SEMICONDUCTOR SOLUTIONS CORPORATION, KANAGAWA (JP)

(72) Inventor: Yusuke KOMATSU, KANAGAWA (JP)

(21) Appl. No.: 18/693,125

(22) PCT Filed: Aug. 4, 2022
(86) PCT No.: PCT/JP2022/029951

§ 371 Date: Mar. 18, 2024

(30) Foreign Application Priority Data
Oct. 1, 2021 (JP) 2021-162840

(51) Int. Cl. G06V 20/58; G01S 13/86; G01S 13/89; G01S 13/931; G06T 15/04; G06T 17/00; G06V 10/764; G06V 10/776; G06V 10/82

(52) U.S. Cl. CPC G06V 20/58; G01S 13/867; G01S 13/89; G01S 13/931; G06T 15/04; G06T 17/00; G06V 10/764; G06V 10/776; G06V 10/82; G01S 2013/932; G06T 2210/56

(57) ABSTRACT

Provided is an information processing apparatus that processes sensor data including speed information of an object. The information processing apparatus includes a generation unit that generates a sensing image on the basis of the sensor data including the speed information of the object, and a detection unit that detects the object from the sensing image using a learned model. The generation unit projects the sensor data including a three-dimensional point cloud on a two-dimensional plane to generate the sensing image having a pixel value corresponding to the speed information. The detection unit performs object detection using the learned model learned to recognize the object included in the sensing image.

### TECHNICAL FIELD

The technology (hereinafter, “the present disclosure”) disclosed in the present specification relates to, for example, an information processing apparatus and an information processing method for processing sensor data acquired by a sensor that recognizes an external world of a moving body, a learning apparatus and a learning method for performing learning of a learning model used for processing sensing data, and a computer program.

### BACKGROUND ART

In order to implement driving assistance and automated driving of a vehicle, it is necessary to detect various objects such as other vehicles, people, and lanes, and it is also necessary to detect objects not only in the daytime when weather is good but also in various environments such as rainy weather and nighttime. Thus, many different types of external recognition sensors such as cameras, millimeter wave radars, and LiDAR have begun to be mounted on vehicles. For example, in order to prevent collision with an obstacle in advance during traveling of a vehicle, it is necessary to grasp a distance from an object ahead such as a preceding vehicle and position information, and radars are used for such a purpose.

For example, in a vehicle equipped with a camera and a radar, there is proposed a display system configured to display position information of an obstacle detected by a radar device to be superimposed on a camera image by using projective transformation between a radar plane and a camera image plane (see Patent Document 1).

### CITATION LIST

### Patent Document

Patent Document 1: Japanese Patent Application Laid-Open No. 2005-175603

### Non-Patent Document

Non-Patent Document 1: Grad-CAM: Visual Explanations from Deep Networks via Gradient-based Localization <https://arxiv.org/abs/1610.02391>

### SUMMARY OF THE INVENTION

### Problems to be Solved by the Invention

The present disclosure aims to provide an information processing apparatus and an information processing method for processing sensor data including speed information of an object, a learning apparatus and a learning method for performing learning of a learning model used for processing sensing data, and a computer program.

### Solutions to Problems

The present disclosure has been made in view of the above problems, and a first aspect thereof is an information processing apparatus including: a generation unit that generates a sensing image on the basis of sensor data including speed information of an object; and a detection unit that detects the object from the sensing image using a learned model.

The generation unit projects the sensor data including a three-dimensional point cloud on a two-dimensional plane to generate the sensing image having a pixel value corresponding to the speed information. Furthermore, the detection unit performs object detection using the learned model learned to recognize the object included in the sensing image.

The generation unit may divide one sensing image into a plurality of sub-images on the basis of the pixel value. Furthermore, the generation unit may add a texture corresponding to the speed information to each of the sub-images. Then, the object may be detected by inputting a time series of each of sub-images divided from each of a plurality of consecutive sensing images to the learned model.

Furthermore, a second aspect of the present disclosure is an information processing method including: a generation step of generating a sensing image on the basis of sensor data including speed information of an object; and a detection step of detecting the object from the sensing image using a learned model.

Furthermore, a third aspect of the present disclosure is a computer program written in a computer-readable format to cause a computer to function as: a generation unit that generates a sensing image on the basis of sensor data including speed information of an object; and a detection unit that detects the object from the sensing image using a learned model.

A computer program according to a third aspect of the present disclosure defines a computer program described in a computer-readable format so as to implement predetermined processing on a computer. In other words, by installing the computer program according to the third aspect of the present disclosure in the computer, a cooperative action is exerted on the computer, and similar operation and effect to those of the information processing apparatus according to the first aspect of the present disclosure can be obtained.

Furthermore, a fourth aspect of the present disclosure is a learning apparatus that performs learning of a model, the learning apparatus including: an input unit that inputs a sensing image generated on the basis of sensor data including speed information of an object to the model; and a model update unit that updates a model parameter of the model by performing error backpropagation to minimize a loss function based on an error between an output label and a correct answer label of the model with respect to the input sensing image.

Furthermore, a fifth aspect of the present disclosure is a learning method for performing learning of a model, the learning method including: an input step of inputting a sensing image generated on the basis of sensor data including speed information of an object to the model; a calculation step of calculating a loss function based on an error between an output label and a correct answer label of the model with respect to the input sensing image; and a model update step of updating a model parameter of the model by performing error backpropagation to minimize the loss function.

Furthermore, a sixth aspect of the present disclosure is a computer program written in a computer-readable format to execute processing for performing learning of a model on a computer, the computer program causing the computer to function as: an input unit that inputs a sensing image generated on the basis of sensor data including speed information of an object to the model; and a model update unit that updates a model parameter of the model by performing error backpropagation to minimize a loss function based on an error between an output label and a correct answer label of the model with respect to the input sensing image.

Furthermore, a seventh aspect of the present disclosure is a learning apparatus that performs learning of a model, the learning apparatus including: a recognition unit that recognizes a camera image; and a model update unit that updates a model parameter of the model by performing error backpropagation to minimize a loss function based on an error between a recognition result by the model and recognition by the recognition unit with respect to a sensing image generated on the basis of sensor data including speed information of an object.

Furthermore, an eighth aspect of the present disclosure is a learning method for performing learning of a model, the learning method including: a recognition step of recognizing a camera image; and a model update step of updating a model parameter of the model by performing error backpropagation to minimize a loss function based on an error between a recognition result by the model and recognition in the recognition step with respect to a sensing image generated on the basis of sensor data including speed information of an object.

Furthermore, a ninth aspect of the present disclosure is a computer program written in a computer-readable format to execute processing for performing learning of a model on a computer, the computer program causing the computer to function as a learning apparatus including: a recognition unit that recognizes a camera image; and a model update unit that updates a model parameter of the model by performing error backpropagation to minimize a loss function based on an error between a recognition result by the model and recognition by the recognition unit with respect to a sensing image generated on the basis of sensor data including speed information of an object.

### Effects of the Invention

According to the present disclosure, it is possible to provide the information processing apparatus and the information processing method for detecting an object using a learned model from sensor data including speed information of the object, the learning apparatus and the learning method for performing learning of a learning model to recognize an object from sensor data including speed information of the object, and a computer program.

Note that the effects described in the present specification are merely examples, and effects brought by the present disclosure are not limited thereto. Furthermore, there is also a case where the present disclosure further provides additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a block diagram illustrating a configuration example of a vehicle control system.

FIG. 2 is a diagram illustrating an example of a sensing area.

FIG. 3 is a diagram illustrating a functional configuration example of an object detection system 300.

FIG. 4 is a view illustrating sensor data acquired by a radar 52.

FIG. 5 is a view illustrating an example of a camera image.

FIG. 6 is a view illustrating a sensing image corresponding to the camera image illustrated in FIG. 5.

FIG. 7 is a view illustrating how sensing images of a plurality of consecutive frames are input to a DNN 701 in time series to detect an object and position information.

FIG. 8 is a view illustrating an example (dense fog) of a camera image.

FIG. 9 is a view illustrating a sensing image corresponding to the camera image illustrated in FIG. 8.

FIG. 10 is a view illustrating a display example of a head-up display based on a detection result of a detection unit 302.

FIG. 11 is a view illustrating how a sensing image is divided into a sub-image of a moving object area and a sub-image of a stationary object area.

FIG. 12 is a view illustrating how a time series of sensing images is divided into a sub-image of a moving object area and a sub-image of a stationary object area.

FIG. 13 is a view illustrating how a sub-image of a moving object area and a sub-image of a stationary object area are input to the DNN in time series.

FIG. 14 is a view for describing a method for adding a texture of a stripe pattern according to speed information of an object to a sensing image.

FIG. 15 is a view for describing the method of adding a texture of a stripe pattern according to speed information of an object to a sensing image.

FIG. 16 is a view illustrating an example in which texture information is added to a sensing image.

FIG. 17 is a view illustrating how a sensing image with texture information is divided into a sub-image of a moving object area and a sub-image of a stationary object area.

FIG. 18 is a view illustrating how a time series of sensing images with texture information is divided into a sub-image of a moving object area and a sub-image of a stationary object area.

FIG. 19 is a view illustrating how a sub-image of a moving object area with texture information and a sub-image of a stationary object area with texture information are input to the DNN in time series.

FIG. 20 is a flowchart illustrating a processing procedure for performing object detection from sensor data of the radar 52.

FIG. 21 is a diagram illustrating a functional configuration example of a learning apparatus 2100.

FIG. 22 is a flowchart illustrating a processing procedure for performing learning of a model on the learning apparatus 2100.

FIG. 23 is a diagram illustrating a functional configuration example of a learning apparatus 2300.

FIG. 24 is a flowchart illustrating a processing procedure for performing learning of a model on the learning apparatus 2300.

### MODE FOR CARRYING OUT THE INVENTION

Hereinafter, the present disclosure will be described in the following order with reference to the drawings.
A. Configuration Example of Vehicle Control System
B. Sensing Area of External Recognition Sensor
C. Function of External Recognition Sensor
D. Object Detection based on Speed Information
D-1. Basic Configuration
D-2. Modified System
D-2-1. Modified Example of Dividing Sensing Image into Areas
D-2-2. Modified Example of Adding Texture Information According to Speed Information
D-3. Processing Procedure
D-4. DNN Learning Process

### A. Configuration Example of Vehicle Control System

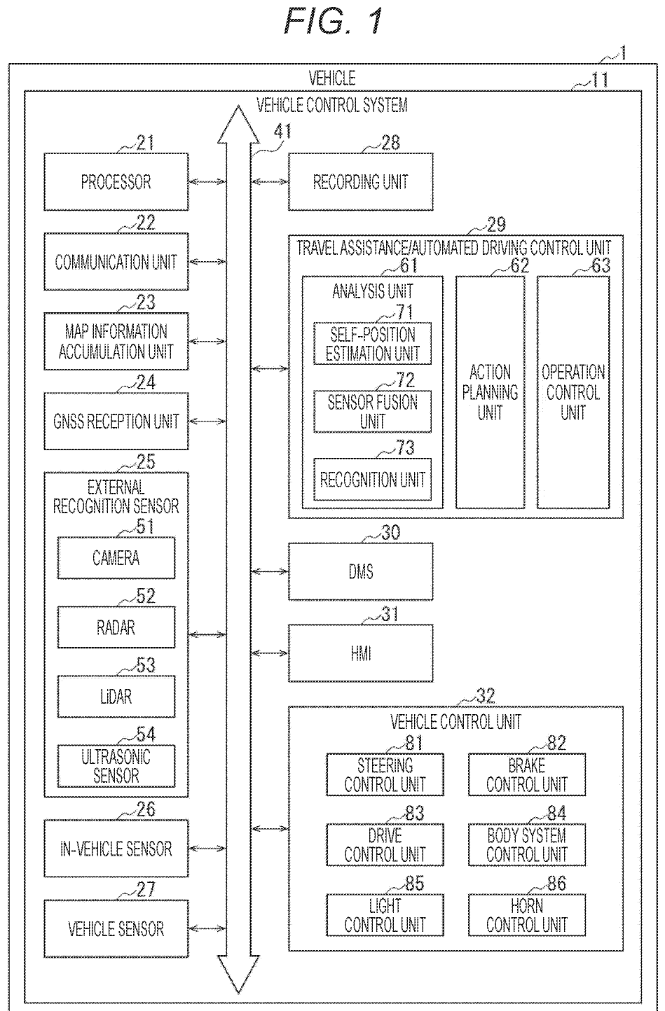

FIG. 1 is a block diagram illustrating a configuration example of a vehicle control system 11 that is an example of a mobile apparatus control system to which the present technology is applied.

The vehicle control system 11 is provided in a vehicle 1 and performs processing relating to travel assistance and automated driving of the vehicle 1.

The vehicle control system 11 includes a vehicle control electronic control unit (ECU) 21, a communication unit 22, a map information accumulation unit 23, a global navigation satellite system (GNSS) reception unit 24, an external recognition sensor 25, an in-vehicle sensor 26, a vehicle sensor 27, a recording unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the GNSS reception unit 24, the external recognition sensor 25, the in-vehicle sensor 26, the vehicle sensor 27, the recording unit 28, the travel assistance/automated driving control unit 29, the driver monitoring system (DMS) 30, the human machine interface (HMI) 31, and the vehicle control unit 32 are communicably connected to each other via a communication network 41. The communication network 41 includes, for example, an in-vehicle communication network, a bus, or the like that conforms to a digital bidirectional communication standard such as a controller area network (CAN), a local interconnect network (LIN), a local area network (LAN), FlexRay®, or Ethernet®. The communication network 41 to be used may be selected according to types of data handled by the communication, and for example, the CAN is applied if data is related to vehicle control, and Ethernet is applied if data has a large volume. Note that the units of the vehicle control system 11 are sometimes directly connected to each other not via the communication network 41, for example, using wireless communication intended for a relatively short-range communication, such as near field communication (NFC) or Bluetooth®.

Note that, hereinafter, in a case where each unit of the vehicle control system 11 performs communication via the communication network 41, the description of the communication network 41 will be omitted. For example, in a case where the vehicle control ECU 21 and the communication unit 22 perform communication via the communication network 41, it is simply described that the processor 21 and the communication unit 22 perform communication.

The vehicle control ECU 21 is configured using, for example, various processors such as a central processing unit (CPU) and a micro processing unit (MPU). The vehicle control ECU 21 controls all or some of the functions of the vehicle control system 11.

The communication unit 22 communicates with various devices inside and outside the vehicle, another vehicle, a server, a base station, and the like, and transmits and receives various data. At this time, the communication unit 22 can perform communication using a plurality of communication schemes.

Communication with the outside of the vehicle executable by the communication unit 22 will be schematically described. The communication unit 22 communicates with a server (hereinafter, referred to as an external server) or the like present on an external network via a base station or an access point by, for example, a wireless communication scheme such as fifth generation mobile communication system (5G), long term evolution (LTE), dedicated short range communications (DSRC), or the like. Examples of the external network with which the communication unit 22 performs communication include the Internet, a cloud network, a company-specific network, and the like. A communication scheme by which the communication unit 22 communicates with the external network is not particularly limited as long as it is a wireless communication scheme capable of performing digital bidirectional communication at a communication speed equal to or higher than a predetermined speed and at a distance equal to or longer than a predetermined distance.

Furthermore, for example, the communication unit 22 can communicate with a terminal present in the vicinity of a host vehicle using a peer to peer (P2P) technology. The terminal present in the vicinity of the host vehicle is, for example, a terminal worn by a moving body moving at a relatively low speed such as a pedestrian or a bicycle, a terminal installed in a store or the like with a position fixed, or a machine type communication (MTC) terminal. Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like possessed by a pedestrian.

For example, the communication unit 22 can receive a program for updating software for controlling the operation of the vehicle control system 11 from the outside (Over The Air). The communication unit 22 can further receive map information, traffic information, information regarding the surroundings of the vehicle 1, and the like from the outside. Furthermore, for example, the communication unit 22 can transmit information regarding the vehicle 1, information regarding the surroundings of the vehicle 1, and the like to the outside. Examples of the information regarding the vehicle 1 transmitted to the outside by the communication unit 22 include data indicating the state of the vehicle 1, a recognition result from a recognition unit 73, and the like. Moreover, for example, the communication unit 22 performs communication corresponding to a vehicle emergency call system such as an eCall.

Communication with the inside of the vehicle executable by the communication unit 22 will be schematically described. The communication unit 22 can communicate with each device in the vehicle using, for example, wireless communication. The communication unit 22 can perform wireless communication with a device in the vehicle by, for example, a communication scheme allowing digital bidirectional communication at a communication speed equal to or higher than a predetermined speed by wireless communication, such as wireless LAN, Bluetooth, NFC, or wireless USB (WUSB). It is not limited thereto, and the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication scheme allowing digital bidirectional communication at a communication speed equal to or higher than a predetermined speed by wired communication, such as universal serial bus (USB), high-definition multimedia interface (HDMI)®, or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver, an information device brought into the vehicle and temporarily installed, or the like is assumed.

For example, the communication unit 22 receives an electromagnetic wave transmitted by a road traffic information communication system (vehicle information and communication system (VICS)®), such as a radio wave beacon, an optical beacon, or FM multiplex broadcasting.

The map information accumulation unit 23 accumulates either or both of a map acquired from the outside and a map created by the vehicle 1. For example, the map information accumulation unit 23 accumulates a three-dimensional high-precision map, a global map having a lower precision than the precision of the high-precision map but covering a wider area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from the external server or the like. The point cloud map is a map including a point cloud (point cloud data). Here, the vector map indicates a map adapted to an advanced driver assistance system (ADAS) in which traffic information such as a lane and a signal position is associated with the point cloud map.

The point cloud map and the vector map may be provided from, for example, the external server or the like, or may be created by the vehicle 1 as a map for performing matching with a local map to be described later on the basis of a sensing result by a radar 52, a LiDAR 53, or the like, and may be accumulated in the map information accumulation unit 23. In addition, in a case where the high-precision map is provided from the external server or the like, for example, map data of several hundred meters square regarding a planned route on which the vehicle 1 is to travel from now is acquired from the external server or the like in order to reduce the communication volume.

The position information acquisition unit 24 receives a GNSS signal from a GNSS satellite and acquires position information of the vehicle 1. The received GNSS signal is supplied to the travel assistance/automated driving control unit 29. Note that the position information acquisition unit 24 is not limited to a scheme using the GNSS signal and may acquire the position information, for example, using a beacon.

The external recognition sensor 25 includes various sensors used to recognize a situation outside the vehicle 1 and supplies sensor data from each sensor to each unit of the vehicle control system 11. Any type and number of sensors included in the external recognition sensor 25 may be adopted.

For example, the external recognition sensor 25 includes a camera 51, the radar 52, the LiDAR 53, and an ultrasonic sensor 54. It is not limited thereto, and the external recognition sensor 25 may include one or more types of sensors among the camera 51, the radar 52, the LIDAR 53, and the ultrasonic sensor 54. The number of cameras 51, the number of radars 52, the number of LiDARs 53, and the number of ultrasonic sensors 54 are not particularly limited as long as they can be practically installed in the vehicle 1. Furthermore, types of sensors provided in the external recognition sensor 25 are not limited to this example, and the external recognition sensor 25 may include sensors of other types. An example of a sensing area of each sensor included in the external recognition sensor 25 will be described later.

Note that the camera 51 may adopt any imaging scheme without particular limitation as long as the imaging scheme enables distance measurement. For example, as the camera 51, cameras of various imaging schemes, such as a time of flight (ToF) camera, a stereo camera, a monocular camera, and an infrared camera, can be applied as necessary. It is not limited thereto, and the camera 51 may simply acquire a captured image regardless of distance measurement.

Furthermore, for example, the external recognition sensor 25 can include an environment sensor for detecting an environment of the vehicle 1. The environment sensor is a sensor for detecting an environment such as weather, climate, or brightness, and can include various sensors such as a raindrop sensor, a fog sensor, a sunshine sensor, a snow sensor, and an illuminance sensor, for example.

Furthermore, for example, the external recognition sensor 25 includes a microphone used for detection or the like of a sound around the vehicle 1 or a position of a sound source.

The in-vehicle sensor 26 includes various sensors for detecting information regarding the inside of the vehicle, and supplies sensor data from each sensor to each unit of the vehicle control system 11. Types and the number of the various sensors included in the in-vehicle sensor 26 are not particularly limited as long as the number can be practically installed in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, for example, cameras of various imaging schemes capable of measuring a distance, such as a ToF camera, a stereo camera, a monocular camera, and an infrared camera, can be used. It is not limited thereto, and the camera included in the in-vehicle sensor 26 may simply acquire a captured image regardless of distance measurement. The biological sensor included in the in-vehicle sensor 26 is provided in, for example, a seat, a steering wheel, or the like, and detects various biological information of the occupant such as the driver.

The vehicle sensor 27 includes various sensors for detecting the state of the vehicle 1, and supplies sensor data from each sensor to each unit of the vehicle control system 11. Types and the number of the various sensors included in the vehicle sensor 27 are not particularly limited as long as the number can be practically installed in the vehicle 1.

For example, the vehicle sensor 27 includes a speed sensor, an acceleration sensor, an angular velocity sensor (gyro sensor), and an inertial measurement unit (IMU) obtained by integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of the engine or the motor, an air pressure sensor that detects the air pressure of the tire, a slip rate sensor that detects a slip rate of the tire, and a wheel speed sensor that detects the rotation speed of the wheel. For example, the vehicle sensor 27 includes a battery sensor that detects the remaining amount and temperature of the battery, and an impact sensor that detects an external impact.

The recording unit 28 includes at least one of a nonvolatile storage medium or a volatile storage medium, and stores data and a program. The recording unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The recording unit 28 records various programs and data used by each unit of the vehicle control system 11. For example, the recording unit 28 includes an Event Data Recorder (EDR) and a Data Storage System for Automated Driving (DSSAD), and records information of the vehicle 1 before and after an event such as an accident and biological information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs a process of analyzing a situation of the vehicle 1 and the surroundings. The analysis unit 61 includes a self-position estimation unit 71, a sensor fusion unit 72, and a recognition unit 73.

The self-position estimation unit 71 estimates a self-position of the vehicle 1 on the basis of sensor data from the external recognition sensor 25 and the high-precision map accumulated in the map information accumulation unit 23. For example, the self-position estimation unit 71 generates a local map on the basis of sensor data from the external recognition sensor 25 and estimates the self-position of the vehicle 1 by matching the local map with the high-precision map. The position of the vehicle 1 is based on, for example, a center of a rear wheel pair axle.

The local map is, for example, a three-dimensional high-precision map created using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) with a predetermined size, and an occupancy state of an object is represented in units of grids. The occupancy state of the object is indicated by, for example, the presence or absence or existence probability of the object. The local map is also used for detection processing and recognition processing for a situation outside the vehicle 1 by the recognition unit 73, for example.

Note that the self-position estimation unit 71 may estimate the self-position of the vehicle 1 on the basis of the GNSS signal and sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). Methods for combining different types of sensor data include integration, fusion, association, or the like.

The recognition unit 73 executes detection processing for detecting a situation outside the vehicle 1 and recognition processing for recognizing the situation outside the vehicle 1.

For example, the recognition unit 73 executes the detection processing and the recognition processing on the situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like on an object around the vehicle 1. The detection processing of the object is, for example, processing of detecting presence or absence, a size, a shape, a position, a motion, and the like of the object. The recognition processing of the object is, for example, processing of recognizing an attribute such as a type of the object or identifying a specific object. However, the detection processing and the recognition processing are not always clearly separated and may overlap.

For example, the recognition unit 73 detects an object around the vehicle 1 by performing clustering to classify a point cloud based on sensor data by the LiDAR 53, the radar 52, or the like for each cluster of the point cloud. Therefore, the presence or absence, a size, a shape, and a position of the object around the vehicle 1 are detected.

For example, the recognition unit 73 detects a motion of the object around the vehicle 1 by performing tracking to follow a motion of the cluster of point clouds classified by clustering. Therefore, a speed and a traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like with respect to the image data supplied from the camera 51. Furthermore, the type of the object around the vehicle 1 may be recognized by performing recognition processing such as semantic segmentation.

For example, the recognition unit 73 can perform recognition processing for traffic rules around the vehicle 1 on the basis of a map accumulated in the map information accumulation unit 23, a result of estimation of the self-position by the self-position estimation unit 71, and a result of recognition of the object around the vehicle 1 by the recognition unit 73. Through this process, the recognition unit 73 can recognize a position and a state of a signal, the contents of traffic signs and road signs, the contents of traffic regulations, travelable lanes, and the like.

For example, the recognition unit 73 can perform recognition processing for a surrounding environment of the vehicle 1. As the surrounding environment to be recognized by the recognition unit 73, weather, temperature, humidity, brightness, road surface conditions, and the like are assumed.

The action planning unit 62 creates an action plan for the vehicle 1. For example, the action planning unit 62 creates an action plan by executing processing of route planning and route following.

Note that the route planning (global path planning) is processing for planning a rough route from a start to a goal. This route planning is called trajectory planning, and also includes processing of trajectory generation (local path planning) that allows safe and smooth traveling near the vehicle 1 in consideration of motion characteristics of the vehicle 1 in the route planned by the route planning. The route planning may be distinguished from long-term route planning, and startup generation from short-term route planning or local route planning. A safety-first route represents a concept similar to startup generation, short-term route planning, or local route planning.

The route following is a process of planning an operation for safely and accurately traveling on the route planned by the route planning within a planned time. For example, the action planning unit 62 can calculate a target speed and a target angular velocity of the vehicle 1 on the basis of a result of this route following processing.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 as described later, and performs acceleration and deceleration control and direction control so that the vehicle 1 travels on a trajectory calculated by the trajectory planning. For example, the operation control unit 63 performs cooperative control for the purpose of implementing the functions of the ADAS such as collision avoidance or impact mitigation, follow-up traveling, vehicle speed maintaining traveling, collision warning of the host vehicle, lane departure warning of the host vehicle, and the like. For example, the operation control unit 63 performs cooperative control for the purpose of automated driving or the like in which the vehicle autonomously travels without depending on the operation of the driver.

The DMS 30 performs authentication processing of the driver, recognition processing of a state of the driver, and the like on the basis of sensor data from the in-vehicle sensor 26, input data input to the HMI 31 as described later, and the like. In this case, as the state of the driver to be recognized by the DMS 30, for example, a physical condition, alertness, a concentration degree, a fatigue degree, a line-of-sight direction, a degree of drunkenness, a driving operation, a posture, and the like are assumed.

Note that the DMS 30 may perform authentication processing of the occupant other than the driver and recognition processing of a state of the occupant. Furthermore, for example, the DMS 30 may perform recognition processing of a situation inside the vehicle on the basis of sensor data from the in-vehicle sensor 26. As the situation inside the vehicle to be recognized, for example, air temperature, humidity, brightness, odor, and the like are assumed.

The HMI 31 receives inputs of various data, instructions, and the like, and presents various data to the driver or the like.

The input of data through the HMI 31 will be schematically described. The HMI 31 includes an input device configured to allow a person to input data. The HMI 31 generates an input signal on the basis of data, an instruction, or the like input by the input device, and supplies the input signal to each unit of the vehicle control system 11. The HMI 31 includes, for example, an operation element such as a touch panel, a button, a switch, and a lever as the input device. It is not limited thereto, and the HMI 31 may further include an input device capable of inputting information by a method such as voice, gesture, or the like other than manual operation. Moreover, the HMI 31 may use, for example, a remote control device using infrared rays or radio waves, or an external connection device such as a mobile device or a wearable device corresponding to the operation of the vehicle control system 11 as an input device.

An overview of the presentation of data performed by the HMI 31 will be described. The HMI 31 generates visual information, auditory information, and tactile information for the occupant or the outside of the vehicle. Furthermore, the HMI 31 performs output control for controlling output, output contents, an output timing, an output method, and the like of each piece of theses generated information. The HMI 31 generates and outputs, as the visual information, information indicated by images or light, such as a manipulation screen, a display of the state of the vehicle 1, a warning display, and a monitor image indicating a situation around the vehicle 1, for example. Furthermore, the HMI 31 generates and outputs, as the auditory information, information indicated by sounds such as voice guidance, a warning sound, and a warning message, for example. Moreover, the HMI 31 generates and outputs, as the tactile information, information given to the tactile sense of the occupant by, for example, force, vibration, a motion, or the like.

As an output device that the HMI 31 outputs the visual information, for example, a display device that presents the visual information by displaying an image by itself or a projector device that presents the visual information by projecting an image can be applied. Note that the display device may be a device that displays the visual information in the field of view of the occupant, such as a head-up display, a transmissive display, or a wearable device having an augmented reality (AR) function, for example, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as the output device configured to output the visual information.

As an output device from which the HMI 31 outputs the auditory information, for example, an audio speaker, a headphone, or an earphone can be applied.

As the output device from which the HMI 31 outputs the tactile information, for example, a haptic element using a haptic technology can be applied. The haptic element is provided, for example, at a portion to be touched by the occupant of the vehicle 1, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a control unit such as an ECU and the like that controls the steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), a regenerative brake mechanism, and the like. The brake control unit 82 includes, for example, a control unit such as an ECU that controls the brake system.

The drive control unit 83 performs detection, control, and the like of a state of a drive system of the vehicle 1. The drive system includes, for example, an accelerator pedal, a driving force generation device for generating a driving force such as an internal combustion engine or a driving motor, a driving force transmission mechanism for transmitting the driving force to wheels, and the like. The drive control unit 83 includes, for example, a control unit such as an ECU that controls the drive system.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a control unit such as an ECU that controls the body system.

The light control unit 85 performs detection, control, and the like of states of various lights of the vehicle 1. As the lights to be controlled, for example, a headlight, a backlight, a fog light, a turn signal, a brake light, a projection light, a bumper indicator, or the like can be considered. The light control unit 85 includes a control unit such as an ECU that performs light control.

The horn control unit 86 performs detection, control, and the like of a state of a car horn of the vehicle 1. The horn control unit 86 includes, for example, a control unit such as an ECU that controls the car horn.

### B. Sensing Area of External Recognition Sensor

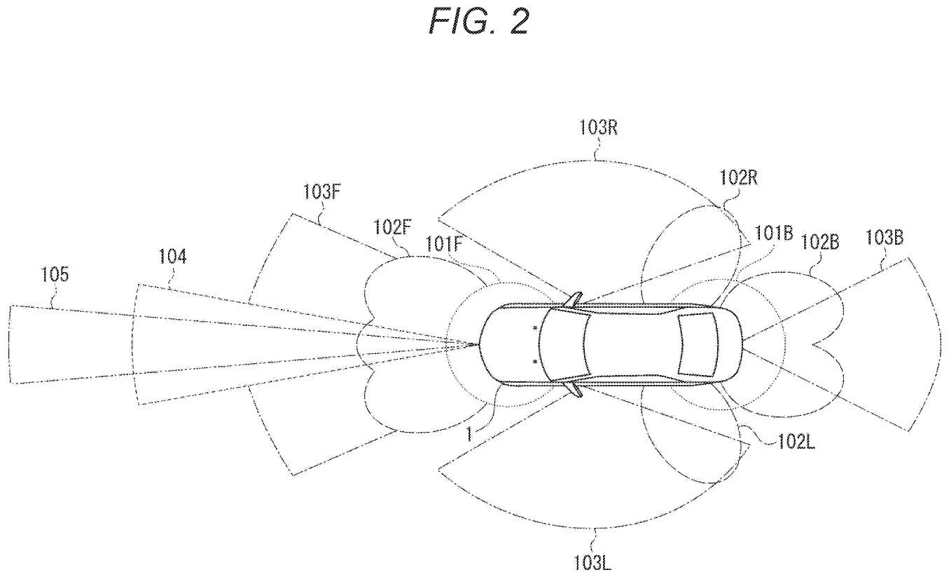

FIG. 2 is a diagram illustrating examples of sensing areas of the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is the front end (front) side of the vehicle 1 and a right end side is the rear end (rear) side of the vehicle 1.

A sensing area 101F and a sensing area 101B are examples of the sensing area of the ultrasonic sensor 54. The sensing area 101F covers a periphery of the front end of the vehicle 1 by a plurality of the ultrasonic sensors 54. The sensing area 101B covers a periphery of the rear end of the vehicle 1 by the plurality of ultrasonic sensors 54.

Sensing results in the sensing area 101F and the sensing area 101B are used for, for example, parking assistance and the like of the vehicle 1.

Sensing areas 102F to 102B are examples of the sensing area of the radar 52 for a short range or a medium range. The sensing area 102F covers a position farther than the sensing area 101F, on the front side of the vehicle 1. The sensing area 102B covers a position farther than the sensing area 101B, on the rear side of the vehicle 1. A sensing area 102L covers a rear periphery of a left side surface of the vehicle 1. A sensing area 102R covers a rear periphery of a right side surface of the vehicle 1.

A sensing result in the sensing area 102F is used for, for example, detection of a vehicle, a pedestrian, or the like present on the front side of the vehicle 1, and the like. A sensing result in the sensing area 102B is used for a collision prevention function and the like on the rear side of the vehicle 1, for example. Sensing results in the sensing areas 102L and 102R are used for detection and the like of an object in a blind spot on the sides of the vehicle 1, for example.

Sensing areas 103F to 103B are examples of the sensing area of the camera 51. The sensing area 103F covers a position farther than the sensing area 102F, on the front side of the vehicle 1. The sensing area 103B covers a position farther than the sensing area 102B, on the rear side of the vehicle 1. A sensing area 103L covers a periphery of the left side surface of the vehicle 1. A sensing area 103R covers a periphery of the right side surface of the vehicle 1.

A sensing result in the sensing area 103F can be used for, for example, recognition of a traffic light or a traffic sign, a lane departure prevention assist system, and an automatic headlight control system. A sensing result in the sensing area 103B is used for, for example, parking assistance, a surround view system, and the like. Sensing results in the sensing areas 103L and 103R can be used for, for example, the surround view system.

A sensing area 104 is an example of the sensing area of the LiDAR 53. The sensing area 104 covers a position farther than the sensing area 103F, on the front side of the vehicle 1. Meanwhile, the sensing area 104 has a narrower range in a left-right direction than the sensing area 103F.

A sensing result in the sensing area 104 is used, for example, for detecting an object such as a surrounding vehicle.

A sensing area 105 is an example of the sensing area of the radar 52 for a long range. The sensing area 105 covers a position farther than the sensing area 104, on the front side of the vehicle 1. Meanwhile, the sensing area 105 has a narrower range in the left-right direction than the sensing area 104.

A sensing result in the sensing area 105 is used for adaptive cruise control (ACC), emergency braking, collision avoidance, and the like, for example.

Note that the respective sensing areas of the sensors, namely, the camera 51, the radar 52, the LiDAR 53, and the ultrasonic sensor 54 included in the external recognition sensor 25 may have various configurations other than the configuration in FIG. 2. Specifically, the ultrasonic sensor 54 may also perform sensing on the sides of the vehicle 1, or the LiDAR 53 may perform sensing on the rear side of the vehicle 1. Furthermore, an installation position of each sensor is not limited to each example described above. In addition, the number of each of the sensors may be one or more.

### C. Function of External Recognition Sensor

The fact that the vehicle control system 11 is equipped with the recognition sensor 25 on the outside including a plurality of types of sensors in order to recognize the situation outside the vehicle 1 has also been described in the above Section A. Examples of significances of being equipped with the plurality of sensors include to compensate advantages and disadvantages of each sensor by another sensor, and to enable improvement in detection accuracy and recognition accuracy by the sensor fusion processing in the sensor fusion unit 72.

The advantages and disadvantages of the respective sensors also depend on detection principles of the respective sensors. However, the respective detection principles are assumed that the radar reflects a radio wave to measure a distance of a target or the like, the camera captures reflected light of visible light from a subject, and the LiDAR reflects light to measure a distance of a target or the like. In the following Table 1, advantages and disadvantages of the millimeter wave radar, the camera, and the LiDAR are summarized in the following Table 1. In the table, “O” means very good (high accuracy), “o” means good (good accuracy), and “A” means poor (insufficient accuracy).

TABLE 1

| Sensor type | Radar | Camera | LIDAR |
|---|---|---|---|
| Measurement | ◯ | Δ | ⊚ |
| distance | | | |
| Angle and | Δ | ⊚ | ◯ |
| resolution | | | |
| Performance in | ⊚ | Δ | ◯ |
| bad weather | | | |
| Performance at | ⊚ | ◯ | ⊚ |
| nighttime | | | |
| Target | Δ | ⊚ | ◯ |
| classification | | | |

From Table 1 described above, it can be seen that, for example, the millimeter wave radar can detect objects (a preceding vehicle, a pedestrian, other obstacles, and the like in a field of view (for example, on the front side of the vehicle) even at nighttime or in bad weather (for example, rainy weather, fog, and the like) where the camera is disadvantageous.

Furthermore, in the above Section A, it has been mentioned that the recognition unit 73 performs the detection processing and the recognition processing of the situation outside the vehicle on the basis of information from the external recognition sensor 25. For example, it has been described that the recognition unit 73 detects an object around the vehicle 1 by performing clustering to classify a point cloud based on sensor data by the LiDAR 53, the radar 52, or the like for each cluster of the point cloud, and further detects a motion of the object around the vehicle 1, that is, a speed and a traveling direction (movement vector) of the object by performing tracking to follow a motion of the cluster of the point cloud classified by the clustering. As described in the above Section B, information such as the motion of the object around the vehicle 1 obtained by the recognition unit 73 performing the detection processing and the recognition processing is used for the ACC, emergency braking, collision avoidance, and the like in the operation control control unit 63.

### D. Object Detection Based on Speed Information

Patent Document 1 proposes a display system that displays position information of an obstacle detected by a radar device to be superimposed on a camera image by using projective transformation between a radar plane and a camera image plane (described above). This display system can detect position information and speed information of an object as an obstacle on the basis of a reflection signal of a millimeter wave radar, and display an arrow indicating a relative speed of the object to be superimposed on the camera image together with a box indicating a position of the detected object.

However, in the display system as disclosed in Patent Document 1, the object detection is not performed on the basis of sensor data by the millimeter wave radar. Thus, in a case where the detection is difficult from the camera image by image recognition, only the relative speed is suddenly displayed on the camera image. For example, in the case of an image obtained by a vehicle-mounted camera capturing an image of the front side of a vehicle at nighttime or in a dense fog, only a relative speed is displayed at a place that cannot be visually recognized from the image, and it is difficult to specify an object that is a target of speed detection by recognition processing of the camera image.

Therefore, the present disclosure proposes a technology for generating a sensing image on the basis of sensor data including speed information measured by a millimeter wave radar or the like, and detecting an object from the sensing image using a learned model. In the present disclosure, a deep neural network (DNN) model obtained by deep learning to detect the object from the sensing image is used as the learned model.

### D-1. Basic Configuration

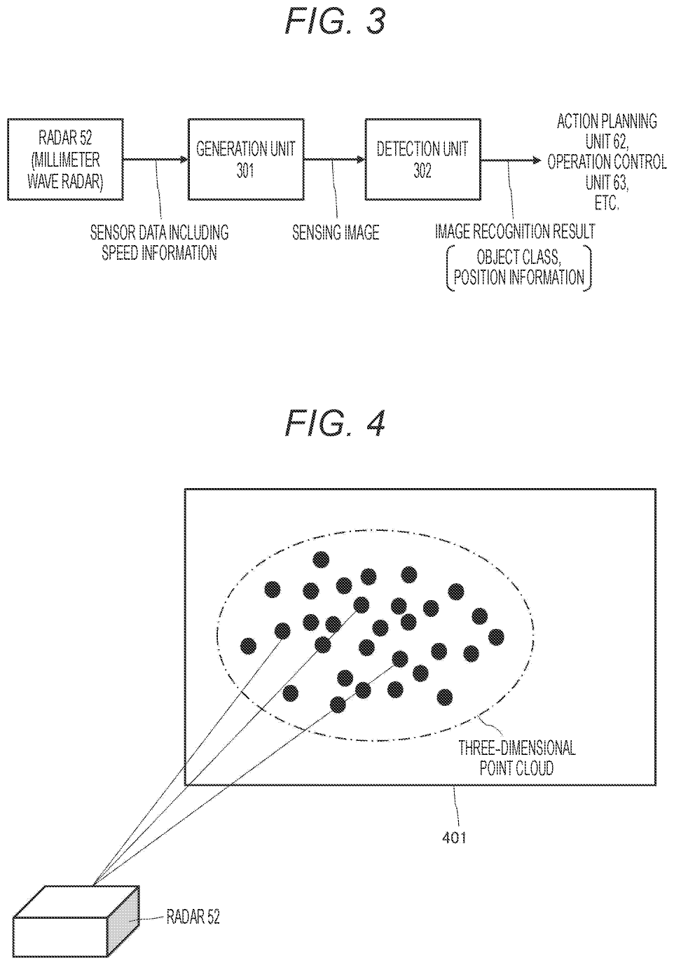

FIG. 3 schematically illustrates a functional configuration example of an object detection system 300 that performs object detection from sensor data including speed information measured by a millimeter wave radar or the like and is achieved by applying the present disclosure. The illustrated object detection system 300 includes a generation unit 301 that generates a sensing image on the basis of sensor data including speed information of an object, and a detection unit 302 that detects the object from the sensing image using a learned model.

The generation unit 301 receives the sensor data including the speed information of the object mainly from the radar 52 (assumed to be the millimeter wave radar here). The radar 52 generates and transmits a modulated wave, receives and processes a reflection signal from the object, and acquires a distance to the object and a speed of the object. A detailed description of the sensing principle by the radar 52 is omitted. However, among pieces of information acquired from the radar 52, the speed information is mainly used in the present embodiment. Furthermore, in a case where the radar 52 is mounted on the vehicle 1 as in the present embodiment, the speed information acquired by the radar 52 is a relative speed of the object with respect to the vehicle 1.

The radar 52 generates the modulated wave by a synthesizer (not illustrated) and sends the modulated wave from an antenna (not illustrated). A range where a signal of the modulated wave arrives is a field of view of the radar 52. Then, the radar 52 can acquire distance information and speed information at each reflection point by receiving the reflection signal from the object in the field of view and performing signal processing such as fast Fourier transform (FFT). FIG. 4 illustrates how the radar 52 acquires the sensor data. As illustrated in FIG. 4, the sensor data obtained from the radar 52 includes a three-dimensional point cloud in which the reflection signal has been captured at each observation point on a three-dimensional space. The radar 52 outputs the sensor data including such a three-dimensional point cloud every frame rate.

The generation unit 301 projects a three-dimensional point cloud as illustrated in FIG. 4 on, for example, a two-dimensional plane 401 on the rear side, and generates a sensing image expressing the speed information of the object in the field of view of the radar 52. The speed information mentioned here means a speed difference between the vehicle 1 and the object, that is, a relative speed. Note that, in a case where an object detection result of the sensing image is collated with a captured image by the camera 51, the sensing image once projected on the two-dimensional plane 401 may be further subjected to projective transformation on a plane of the camera image. Typically, installation positions of the radar 52 and the camera 51 do not coincide with each other, that is, a coordinate system of the radar 52 and a coordinate system of the camera 51 do not coincide with each other. Thus, a projective transformation matrix for projecting the radar coordinate system onto the plane of the camera coordinate system is only required to be obtained in advance.

Furthermore, when each observation point in the three-dimensional space by the radar 52 is projected on the two-dimensional plane, the generation unit 301 gives a pixel value corresponding to speed information to each pixel. Therefore, the sensing image generated by the generation unit 301 can also be referred to as a “speed image” in which each pixel expresses the speed information. The generation unit 301 generates the sensing image at the same frame rate as the radar 52.

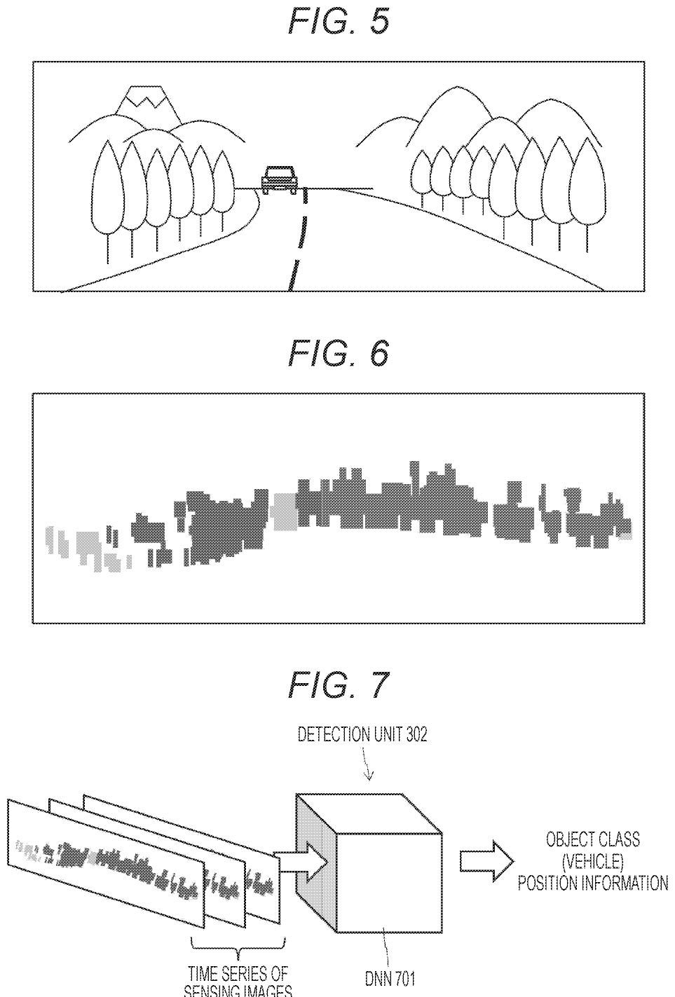

FIG. 5 illustrates an example of a camera image in which the front side of the vehicle 1 is captured by the camera 51. A preceding vehicle appears substantially at the center of the illustrated camera image. Furthermore, FIG. 6 illustrates a sensing image generated by the generation unit 301 from sensor data acquired by the radar 52 at the same timing as in FIG. 5 (but, for convenience of the description, it is assumed that the sensing image is subjected to projective transformation from a laser coordinate system to the camera coordinate system, and each pixel position corresponds between the camera image and the sensing image). As illustrated in FIG. 6, the sensing image is an image in which each pixel has a gradation according to the speed information (relative speed between the vehicle 1 and the object). Note that an area having no speed information because no reflection signal has been received is drawn in white in FIG. 6. When FIG. 5 is compared with FIG. 6, in the sensing image, an area corresponding to the preceding vehicle is expressed by a different pixel value (a difference in gradation in FIG. 6) from a peripheral area due to a speed difference.

Note that sensing image generation processing in the generation unit 301 may be performed in the radar 52 or a module of the external recognition sensor 25, or may be performed in the recognition unit 73. Furthermore, the generation unit 301 generates a sensing image from sensor data of the radar 51 in the present embodiment, but can similarly generate a sensing image from sensor data acquired from another sensor such as the LiDAR 53 or a sound wave sensor.

Furthermore, the example in which a sensing image is generated from sensor data output from the radar 52 such as the millimeter wave radar has been described in the present embodiment, but a sensing image can be similarly generated from output data of another sensor capable of acquiring speed information, such as the LiDAR 53 or the sound wave sensor.

The detection unit 302 detects an object and a position of the object using the learned model from the sensing image in which the speed information is represented by the pixel value for each pixel as illustrated in FIG. 6. Examples of the applicable learned model include a DNN using a multilayer convolutional neural network (CNN). It is assumed that the DNN has been learned to detect the object from the sensing image.

In general, the CNN includes a feature amount extraction unit that extracts a feature amount of an input image, and an image classification unit that infers an output label (identification result) corresponding to the input image on the basis of the extracted feature amount. The former feature amount extraction unit includes a “convolution layer” that extracts an edge or a feature by performing convolution of an input image by a method of limiting connection between neurons and sharing a weight, and a “pooling layer” that deletes information on a position that is not important for image classification and gives robustness to the feature extracted by the convolution layer.

Furthermore, a specific example of the CNN is ResNet-50. Resnet has a shortcut connection mechanism in which an input from the previous layer is skipped over and then added together with a normally calculated value, so that some skipped layers are only required to predict a residual from the input from previous layers. ResNet-50 has a layer depth of 50 layers. Of course, the present disclosure is not limited to ResNet-50.

In the present embodiment, a DNN obtained by deep learning of the CNN in advance is used so as to detect an object and a position of the object from a sensing image generated from speed information acquired by the radar 52. However, the CNN may be trained to detect only an object from the sensing image, and position information of the object in the sensing image may be extracted using an explainable AI (XAI) technology such as gradient-weighted class activation mapping (Grad-CAM) (for example, see Non-Patent Document 1).

A DNN used for normal RGB image recognition may be directly applied to sensing image recognition. In the present embodiment, not an RGB image but the sensing image described above is subjected to deep learning on the CNN and used by the detection unit 302. It can also be said that a DNN for image recognition becomes available by generating the sensing image on the two-dimensional plane from the sensor data by the radar 52. A method for learning the sensing image will be described later.

FIG. 7 illustrates how sensing images of a plurality of consecutive frames (three frames in an example illustrated in FIG. 7) are input to a DNN 701 in time series to detect an object (“vehicle”) and position information in the sensing images in the detection unit 302. Deep learning of the DNN 701 may be performed so as to detect an object from a plurality of consecutive frames. Of course, learning of the DNN 701 may be performed so as to detect an object from one frame.

Then, the detection unit 302 outputs a class (“vehicle”, “pedestrian”, “guardrail”, “street tree”, “sign”, . . . , or the like) of an object included in a sensing image and position information on an image frame of the object detected using such a DNN to, for example, the action planning unit 62 and the operation control unit 63. The action planning unit 62 and the operation control unit 63 can perform the vehicle such as emergency braking and collision avoidance on the basis of a preceding vehicle detected by the detection unit 302 and its position information. Furthermore, the HMI 31 may display information regarding an object detected by the detection unit 302 on a head-up display or a monitor screen indicating a situation around the vehicle 1.

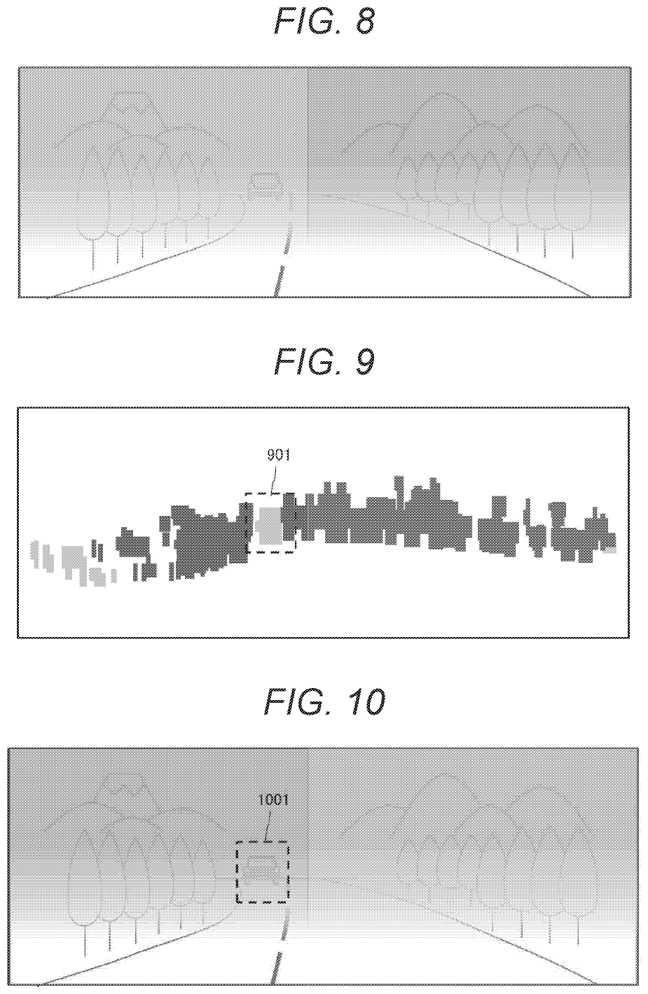

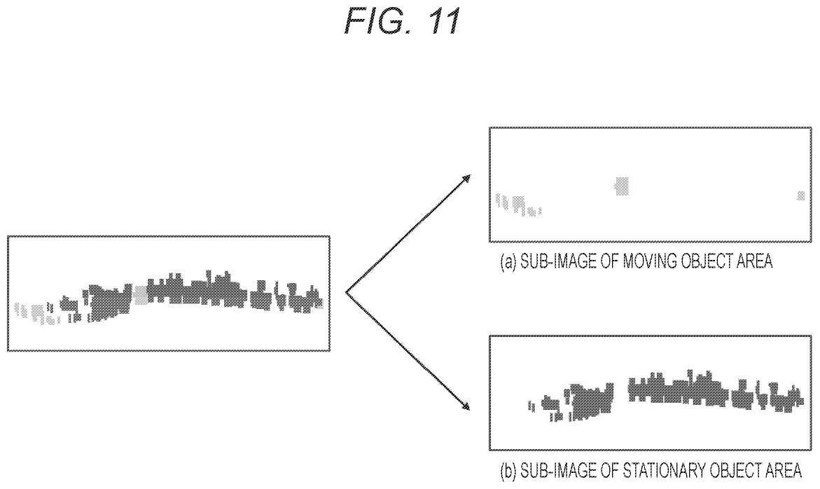

For example, in a case where the front side of the vehicle 1 is captured by the camera 51 under an environment such as nighttime or dense fog, it is difficult to detect an object such as a preceding vehicle from a camera image. On the other hand, since the radar 52 originally has high object detection performance even at nighttime or in bad weather, it is easy to detect an object that is difficult to detect from the camera image if a sensing image generated on the basis of sensor data of the radar 52 is used. Referring to FIG. 8, it is difficult to visually recognize the preceding vehicle from the camera image due to dense fog, and thus, it is expected that it is difficult to detect the preceding vehicle even if the camera image is input to an object detector. Furthermore, FIG. 9 illustrates a sensing image generated by the generation unit 301 from sensor data acquired by the radar 52 at the same timing as in FIG. 8. With the radar 52, it is possible to capture an object in the field of view without being affected by weather and brightness. Referring to FIG. 9, an area 901 corresponding to the preceding vehicle is expressed by a different pixel value from a peripheral area due to a speed difference without being affected by fog or rain, it can be expected that the preceding vehicle can be detected with high accuracy from the sensing image using the DNN. As illustrated in FIG. 10, a box 1001 indicating the preceding vehicle detected by the detection unit 302 may be displayed on a head-up display or a monitor screen in an environment such as nighttime or dense fog to warn a driver.

Note that processing for detecting an object from a sensing image in the detection unit 302 may be performed in any module of the external recognition sensor 25 or the recognition unit 73.

### D-2. Modified Examples

In this Section D-2, modified examples for mainly improving sensing image recognition performance will be described.

### D-2-1. Modified Example of Dividing Sensing Image into Areas

A sensing image is an image obtained by projecting each observation point on a three-dimensional space by the radar 52 on a two-dimensional plane with a pixel value corresponding to speed information. Meanwhile, as can be seen from FIG. 6, the sensing image is a monotonous image in which each pixel has a pixel value corresponding to the speed information (a speed difference from the vehicle 1). Thus, there is a concern that sufficient detection accuracy by the DNN cannot be obtained as compared with a camera image having a large amount of information such as an object shape and surface texture. In other words, it is difficult for the DNN to learn the sensing image as it is.

Therefore, as a modified example, a method is proposed in which a sensing image of one frame is divided into a sub-image obtained by extracting an area of a moving object and a sub-image obtained by extracting an area of a stationary object on the basis of pixel values, and these two types of sub-images are input to the DNN to emphasize a difference between whether each object is moving or stationary, thereby improving detection accuracy of the DNN. It can be also expected that learning efficiency of the DNN is improved by learning the sensing image divided into the moving object area and the stationary object area.

Here, the moving object is, for example, a surrounding vehicle such as a preceding vehicle or an oncoming vehicle, a pedestrian, or the like. The moving object area is an area where radar output from the radar 52 hits these moving objects. Furthermore, the stationary object is a guardrail, a wall, a street tree, a sign, or the like. The stationary object area is an area where radar output from the radar 52 hits these stationary objects.

A relative speed (a speed difference from the vehicle 1) of a moving object moving in the same direction as that of the vehicle 1, such as a preceding vehicle, is small. Furthermore, a relative speed of an animal zone moving in a direction opposite to that of the vehicle 1, such as an oncoming vehicle, is large. Meanwhile, a relative speed of the stationary object such as a guardrail, a wall, a street tree, or a sign is substantially equal to a moving speed (absolute speed) of the vehicle 1. Therefore, in a sensing image in which pixel values are represented by 256 tones, an area in which pixel values are less than 118 or more than 136 is the moving object area, and an area in which pixel values are 118 or more and 138 or less is the stationary object area. FIG. 11 illustrates how the sensing image illustrated in FIG. 6 is divided into a sub-image of (a) in the drawing including moving object areas in which pixel values are less than 118 or more than 136 and a sub-image of (b) in the drawing including stationary object areas in which pixel values are 118 or more and 138 or less.

Since the sensing image generated by the generation unit 301 is divided into the sub-image obtained by extracting the moving object areas and the sub-image obtained by extracting the stationary object areas and then input to the DNN, the detection unit 302 can improve the object detection accuracy. Processing for dividing one sensing image into a plurality of sub-images can be performed by the generation unit 301, for example, but may be performed by the detection unit 302. Furthermore, it can be also expected that the learning efficiency of the DNN is improved by performing learning of the sensing image divided into the moving object area and the stationary object area.

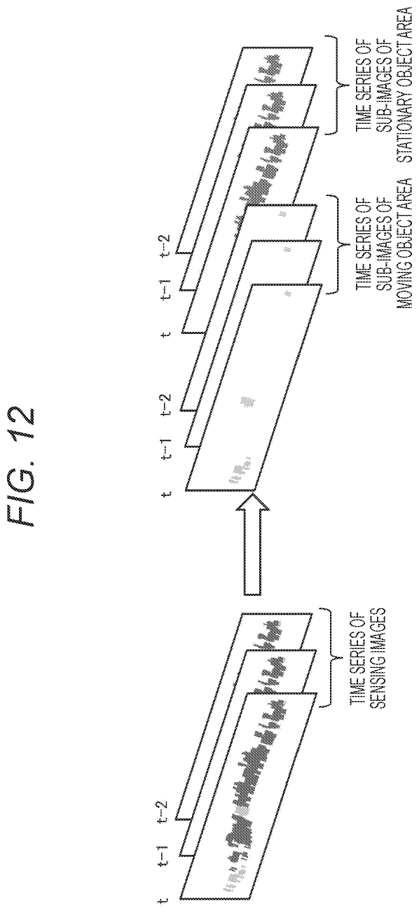

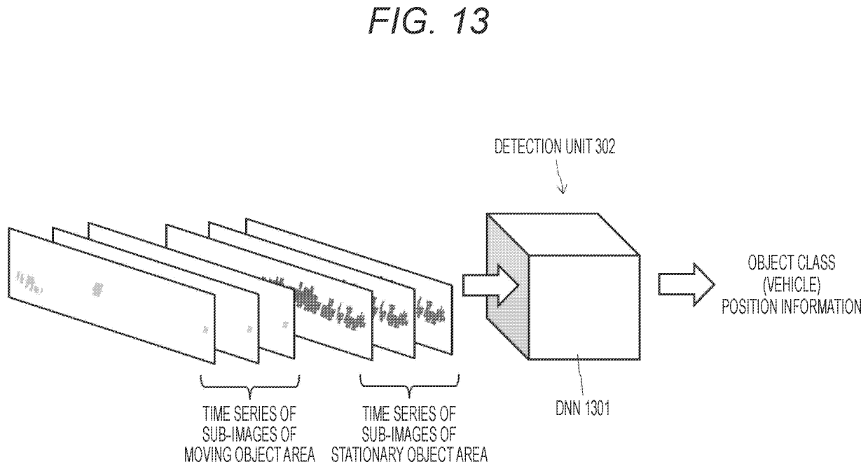

FIG. 7 illustrates the example in which the sensing images of the plurality of consecutive frames are input to the DNN in time series to perform the object detection. In a case where the sensing image is divided into the sub-image of the moving object area and the sub-image of the stationary object area, the respective sub-images are only required to be input to the DNN in time series. FIG. 12 illustrates how sensing images at times t-2, t-1, and t are divided into sub-images of moving object areas at the times t-2, t-1, and t and sub-images of stationary object areas at the times t-2, t-1, and t. Furthermore, FIG. 13 illustrates how the divided sub-images of moving object areas and the divided sub-images of stationary object areas are input to a DNN 1301 in time series. In such a case, deep learning of the DNN 1301 may be performed so as to detect an object from the time series of the sub-images of moving object areas and the time series of the sub-images of stationary object areas.

### D-2-2. Modified Example of Adding Texture Information According to Speed Information

In the above Section D-2-1, the modified example in which the sensing image is divided into the sub-image of the moving object area and the sub-image of the stationary object area and input to the DNN has been described in order for the DNN to easily identify an area of an area stationary object of the moving object in the sensing image. Section D-2-2 proposes a modified example in which a difference in speed for each object is emphasized by further adding texture information according to speed information to each area, thereby further improving the detection accuracy of the DNN. It can be also expected that the learning efficiency of the DNN is improved by learning a sensing image including the texture information according to the speed information.

As an example, a method for adding a texture of a stripe pattern according to speed information of an object to a sensing image will be described with reference to FIGS. 14 and 15.

FIG. 14(a) illustrates an area of an object having a pixel value of 180 in the sensing image. As described above, a pixel value according to speed information of the corresponding object is assigned to each pixel of the sensing image. Here, it is possible to add the texture of vertical stripes to the area having the original uniform pixel value (gradation) by generating areas in which the pixel value is halved to 90 at predetermined intervals in the horizontal direction as illustrated in FIG. 14(b).

Moreover, the texture of the stripe pattern is completed by changing an orientation of the stripe pattern according to the original pixel value (that is, before adding the texture). For example, the orientation of the stripe pattern is changed by 0.7 degrees F. or each pixel value 1 (pixel value: orientation=1:0.7°). For example, after the areas in which the pixel value is halved to 90 are generated at predetermined intervals in the horizontal direction and the texture of vertical stripes is added as illustrated in FIG. 15(a), a texture as illustrated in FIG. 15(b) can be added by changing the orientation by 0.7 degrees F. or each pixel value 1, and therefore by 126 degrees with respect to the pixel value of 180.

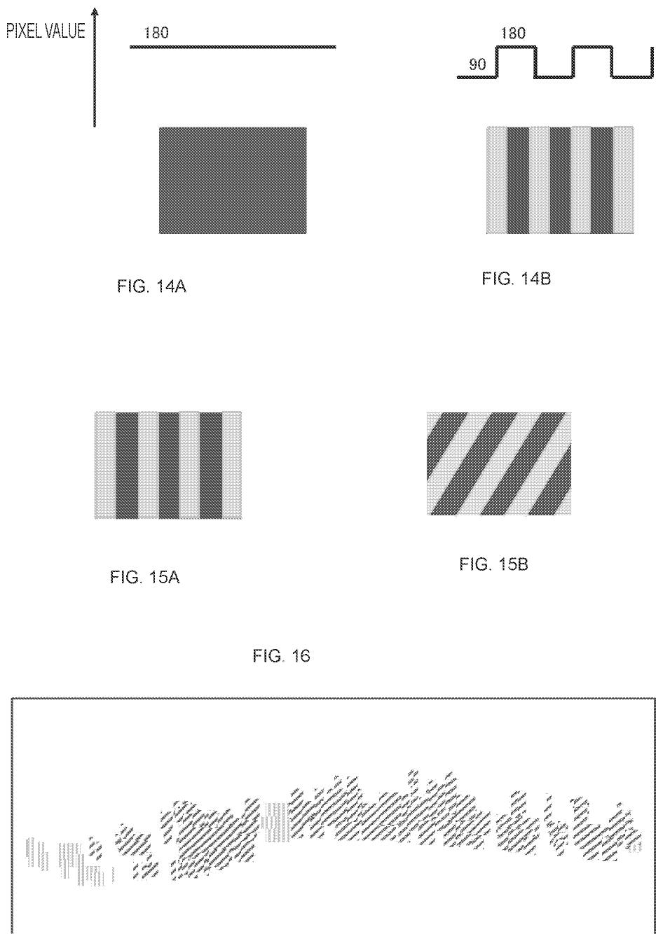

FIG. 16 illustrates an example in which texture information including a stripe pattern according to speed information is applied to the sensing image illustrated in FIG. 6 by the method illustrated in FIGS. 14 and 15. It should be understood that a difference in speed can be further emphasized by adding the test information as compared with a case where speed information is expressed only by a pixel value.

Note that adding the texture of the stripe pattern is merely an example. Other textures such as dots and grids may be added according to speed information.

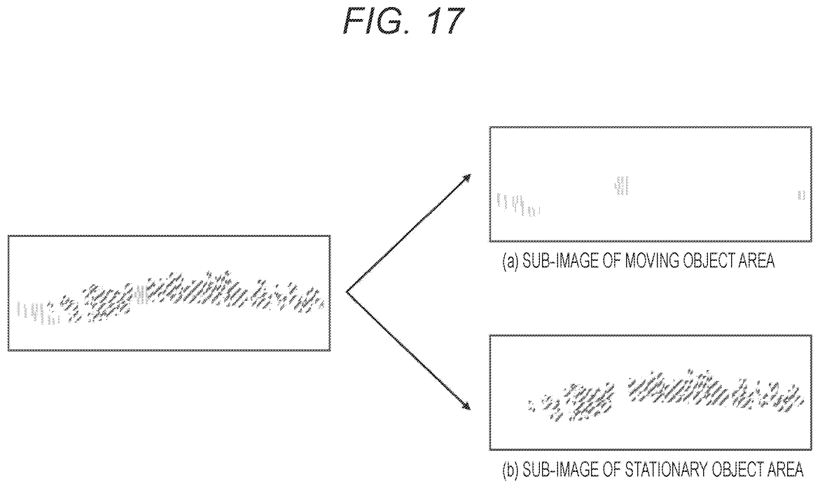

Even in a case where texture information according to speed information is added to a sensing image, the sensing image may be divided into a sub-image including a moving object area and a sub-image including a stationary object area and input to the DNN similarly to the case described in the above Section D-2-1. FIG. 17 illustrates how the sensing image with the texture information illustrated in FIG. 16 is divided into a sub-image including moving object areas of (a) in the drawing and a sub-image including stationary object areas of (b) in the drawing. Since the sensing image with the texture information is divided into the sub-image obtained by extracting the moving object areas and the sub-image obtained by extracting the stationary object areas, and then input to the DNN, the detection unit 302 can improve the object detection accuracy.

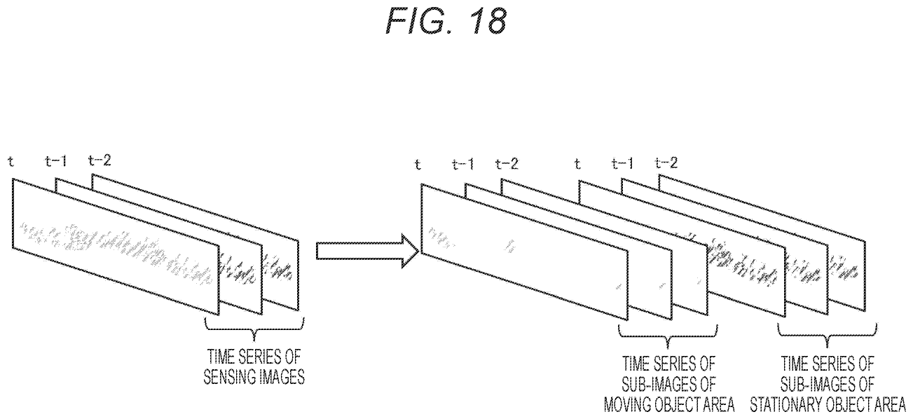

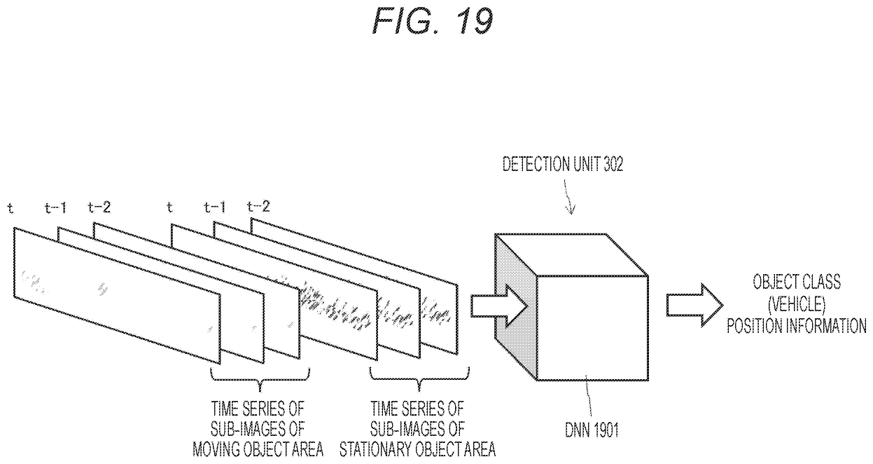

Furthermore, in a case where texture information according to speed information is added to a sensing image, each sub-image may be input to the DNN in time series similarly to the case described in the above Section D-2-1. FIG. 18 illustrates how sensing images at times t-2, t-1, and t are divided into sub-images of moving object areas at the times t-2, t-1, and t and sub-images of stationary object areas at the times t-2, t-1, and t. Furthermore, FIG. 19 illustrates how the divided sub-images of moving object areas and the divided sub-images of stationary object areas are input to a DNN 1901 in time series.

### D-3. Processing Procedure

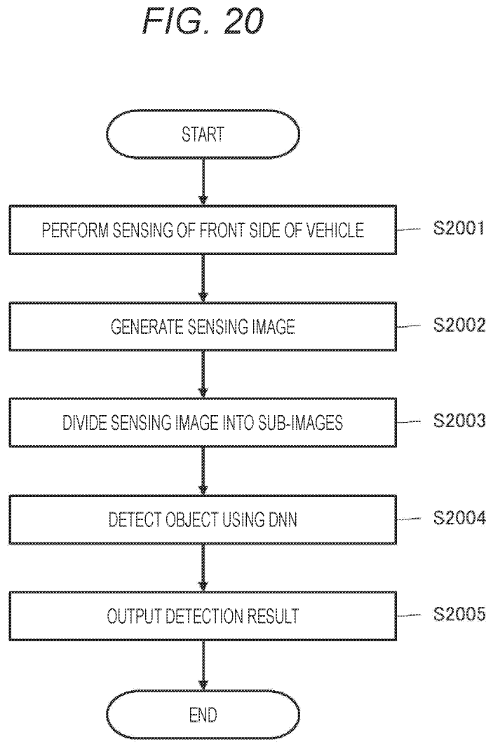

In Section D-3, a processing procedure for performing object detection from sensor data of the radar 52 in the object detection system 300 illustrated in FIG. 3 will be described. FIG. 20 illustrates this processing procedure in the form of a flowchart.

First, for example, sensing of the front side of the vehicle 1 is performed using the radar 52 (step S2001). The radar 52 generates and transmits a modulated wave, receives a reflection signal from an object in the field of view, and performs signal processing to acquire sensor data (see FIG. 4) including the three-dimensional point cloud representing speed information at each observation point in the three-dimensional space. Note that, although the sensing of the front side of the vehicle 1 is performed here for convenience of explanation, sensing of the left and right sides of the vehicle 1 or the rear side of the vehicle 1 may be performed.

Next, the generation unit 301 projects the sensor data of the radar 52 including the three-dimensional point cloud on a two-dimensional plane, and generates a sensing image in which each pixel has a pixel value according to the speed information (step S2002). Note that the sensing image may be generated at each observation point in the three-dimensional space.

Next, as described in the above Section D-2-1, the sensing image is divided into a sub-image obtained by extracting an area of a moving object and a sub-image obtained by extracting an area of a stationary object (step S2003). The division processing into sub-images may be performed by either the generation unit 301 or the detection unit 302. Furthermore, as described in the above Section-2-2, texture information according to the speed information may be added to each sub-image.

Then, the detection unit 302 inputs the sub-image of the moving object area and the stationary sub-image to the DNN in time series, and detects objects included in the sensing images (step S2004).

The DNN receives the input of a time series of the sensing images in the form divided into the sub images, and detects positions of the respective objects including the moving object such as a preceding vehicle and the stationary object such as a wall or a guardrail. Then, the detection unit 302 outputs a detection result by the DNN to, for example, the action planning unit 62 or the operation control unit 63 (step S2005). The action planning unit 62 and the operation control unit 63 can perform the vehicle such as emergency braking and collision avoidance on the basis of a preceding vehicle detected by the detection unit 302 and its position information. Furthermore, the HMI 31 may display information regarding an object detected by the detection unit 302 on a head-up display or a monitor screen indicating a situation around the vehicle 1.

### D-4. Learning Process of Learning Model

In the present embodiment, a learning model constructed by deep learning is used for sensing image recognition processing in the detection unit 302. In Section D-4, a learning process of a learning model used by the detection unit 302 will be described.

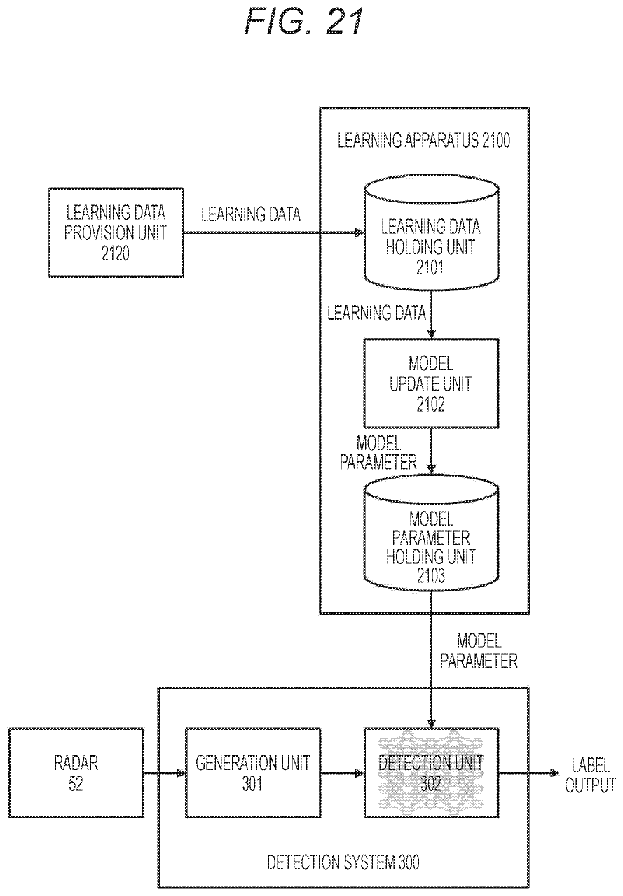

FIG. 21 schematically illustrates a functional configuration example of a learning apparatus 2100 that performs learning of a learning model used in the detection unit 302. The illustrated learning apparatus 2100 includes a learning data holding unit 2101, a model update unit 2102, and a model parameter holding unit 2103. Furthermore, the learning apparatus 2100 is further provided with a learning data provision unit 2120 that provides learning data to be used for learning of a machine learning model. Some or all of the functions the learning apparatus 2100 are constructed on a cloud or an arithmetic device capable of large-scale computation, but may be mounted on an edge device and used.

The learning data provision unit 2120 supplies learning data to be used by the model update unit 2102 for model learning. Specifically, the learning data includes a data set (x, y) obtained by combining a sensing image as input data x that is input to a target learning model and an object as a correct answer label y that is a correct answer for the sensing image. For example, the learning data provision unit 2120 may provide, to the learning apparatus 2100, sensing images collected from many vehicles and detection results thereof as the learning data.

The learning data holding unit 2101 accumulates learning data to be used by the model update unit 2102 for model learning. Each piece of the learning data includes a data set obtained by combining input data to be input to a learning target model and a correct answer label to be inferred by the model (as described above). While the learning data holding unit 2101 accumulates data sets provided from the learning data provision unit 2130, it may accumulate data sets obtained from another source. In a case where the model update unit 2102 performs deep learning, it is necessary to accumulate a huge amount of data sets in the learning data holding unit 2101.

The model update unit 2102 sequentially reads the learning data from the learning data holding unit 2101 to perform learning of a target learning model and updates a model parameter. The learning model is configured by a neural network such as a CNN, for example, but may be a model using a type such as support vector regression or Gaussian process regression. The model configured by the neural network has a multilayer structure including an input layer that receives data (explanatory variable) such as an image, an output layer that outputs a label (objective variable) serving as an inference result for the input data, and one or a plurality of intermediate layers (or hidden layers) between the input layer and the output layer. Each of the layers includes a plurality of nodes corresponding to neurons. Coupling between the nodes across the layers has a weight, and a value of the data input to the input layer is transformed as the data passes from layer to layer. For example, the model update unit 2102 calculates a loss function defined on the basis of an error between a label output from the model for the input data and a correct answer label corresponding to the input data, and leans the model while updating the model parameter (a weight coefficient between nodes or the like) by error backpropagation in such a manner that the loss function is minimized. Note that the learning process is enormous in calculation amount, the model update unit 2102 may perform distributed learning using a plurality of calculating graphics processing units (GPUs) or a plurality of nodes.

Then, the model update unit 2102 stores the model parameter obtained as a learning result in the model parameter holding unit 2103. The model parameter is a variable element that defines the model, and is, for example, a coupling weight coefficient or the like to be given between nodes of the neural network.

In the detection system 300, when object detection is performed on the basis of sensor data from the radar 52, first, the generation unit 301 projects sensor data including a three-dimensional point cloud on a two-dimensional plane to generate a sensing image. Then, the detection unit 302 outputs an object label inferred from the input sensing image using the model in which the model parameter read from the model parameter holding unit 2103 is set, that is, the learned model.

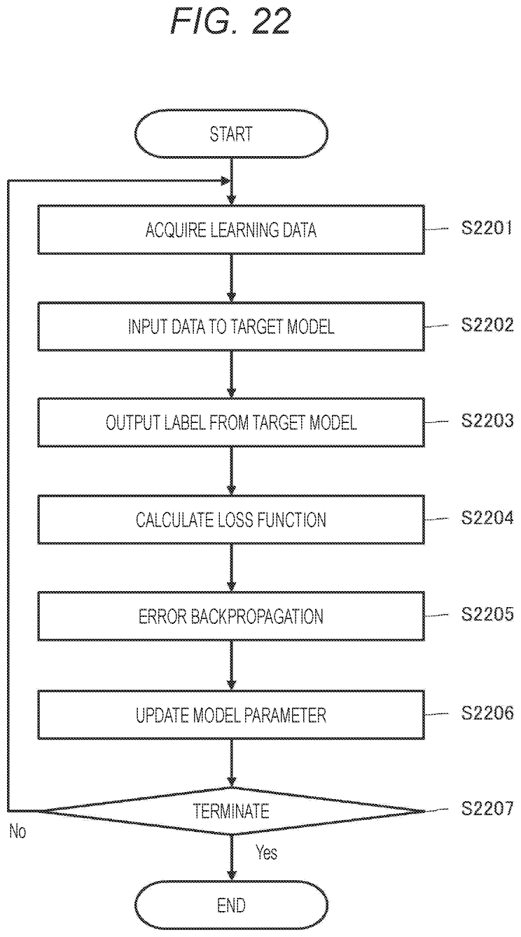

FIG. 22 illustrates a processing procedure for performing learning of a model on the learning apparatus 2100 in the form of a flowchart.

First, the model update unit 2102 reads learning data including a data set of a sensing image and a correct answer label from the learning data holding unit 2101 (step S2201). Then, the model update unit 2102 inputs the read sensing image to a model being learned, and acquires an output label inferred by the model at a current learning stage (step S2202).

Next, when acquiring the label output from the model with respect to the input sensing image (step S2203), the model update unit 2102 obtains a loss function based on an error between the output label and the correct answer label (step S2204). Then, the model update unit 2102 performs error backpropagation so as to minimize the loss function (step S2205), and updates a model parameter of the model to be learned (step S2206). The updated model parameter is accumulated in the model parameter holding unit 2103.

Thereafter, the model update unit 2102 checks whether or not a learning end condition of the target model is reached (step S2207). For example, the number of times of learning may be set as the end condition, or a state where an expected value of the output label of the model is a predetermined value or more may be set as the end condition. When the end condition is reached (Yes in step S2207), the model learning process is ended. Furthermore, if the end condition is not reached yet (No in step S2207), the processing returns to step S2201 to repeatedly execute the model learning process described above.

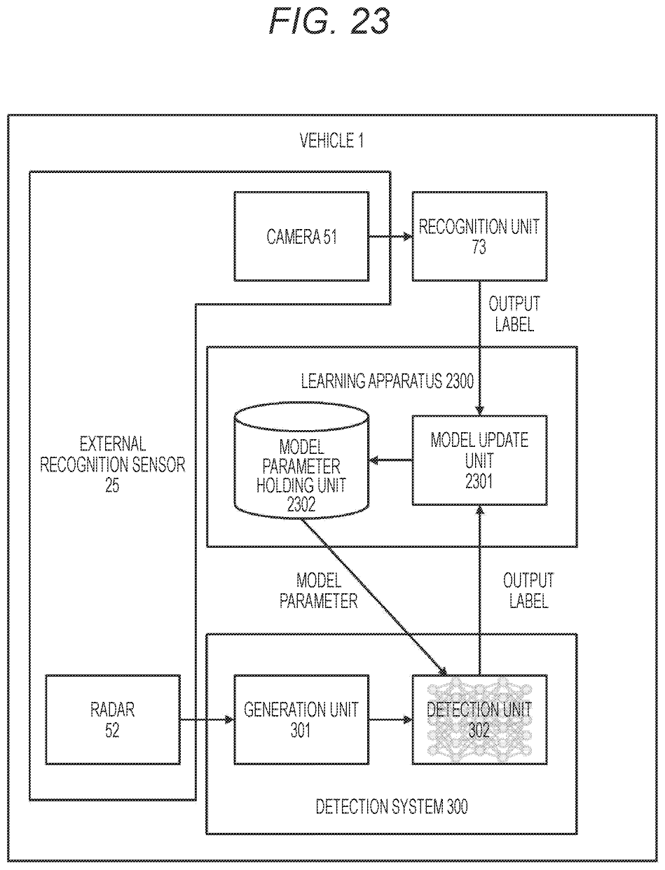

FIG. 23 schematically illustrates a functional configuration example of a learning apparatus 2300 according to another example that performs learning of a learning model used in the detection unit 302. The main features of the learning apparatus 2300 are that it can be used by being mounted on the vehicle 1 and that a result of recognizing, by the recognition unit 73, a camera image obtained by capturing an image of the front side (or surroundings) of the vehicle 1 by the camera 51 can be used as learning data. The learning apparatus 2300 includes a model update unit 2301 and a model parameter holding unit 2302.

For example, while the vehicle 1 is being driven, the image of front side (or surroundings) of the vehicle is captured by the camera 51. Then, the recognition unit 73 detects an object from a camera image using, for example, an object detector including a learned model (a DNN or the like).

On the other hand, on the detection system 300 side, the generation unit 301 projects sensor data including a three-dimensional point cloud from the radar 52 on a two-dimensional plane to generate a sensing image. Note that it is preferable to perform projective transformation processing from a radar coordinate system to a camera coordinate system on the sensing image in order to maintain consistency with a recognition result for the camera image. Then, the detection unit 302 outputs an object label inferred from the input sensing image using a model in which a model parameter read from the model parameter holding unit 2303 is set, that is, the model being learned.

The model update unit 2301 calculates a loss function defined on the basis of an error between a label output from the recognition unit 73 with respect to the camera image captured by the camera 51 and the label output from the detection unit 302 with respect to the sensing image, and performs learning of the model while updating the model parameter (such as a weighting coefficient between nodes) by error backpropagation such that the loss function is minimized. That is, the learning of the model is performed using the result of recognizing the camera image by the recognition unit 73 as the learning data.

Since the learning data can be always obtained on the basis of the camera image by the camera 51 by using the learning apparatus 2300 mounted on the vehicle 1, the learning apparatus 2300 can perform learning (re-learning and additional learning) of the model used in the detection unit 302 even during movement of the vehicle 1. For example, in a case where routes on which the vehicle 1 passes are limited, portions of stationary object areas in the sensing image are limited, and thus, it is possible to implement learning of the model adapted to individual needs such as a route for each vehicle.

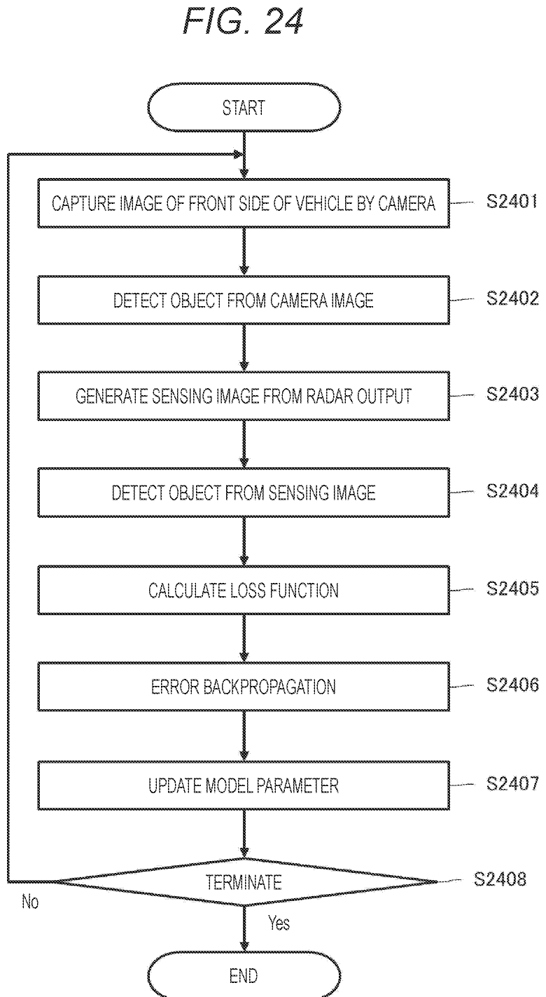

FIG. 24 illustrates a processing procedure for performing model learning on the learning apparatus 2300 in the form of a flowchart.

First, an image of the front side (or surroundings) of the vehicle is captured by the camera 51 (step S2401). Then, the recognition unit 73 detects an object from a camera image using, for example, an object detector including a learned model (a DNN or the like) (step S2402).

On the other hand, on the detection system 300 side, the generation unit 301 projects sensor data including a three-dimensional point cloud from the radar 52 on a two-dimensional plane to generate a sensing image (step S2403). At that time, it is preferable to perform projective transformation processing from a radar coordinate system to a camera coordinate system on the sensing image in order to maintain consistency with a recognition result for the camera image.

Next, the detection unit 302 outputs an object label inferred from the input sensing image using a model in which a model parameter read from the model parameter holding unit 2303 is set, that is, the model being learned (step S2404).

Next, the model update unit 2301 calculates a loss function defined on the basis of an error between a label output from the recognition unit 73 with respect to the camera image captured by the camera 51 and the label output from the detection unit 302 with respect to the sensing image (step S2405).

Then, the model update unit 2301 performs error backpropagation so as to minimize the loss function (step S2406), and updates the model parameters of the learning target model (step S2407). The updated model parameter is accumulated in the model parameter holding unit 2302.

Thereafter, the model update unit 2102 checks whether or not a learning end condition of the target model is reached (step S2408). For example, the number of times of learning may be set as the end condition, or a state where an expected value of the output label of the model is a predetermined value or more may be set as the end condition. When the end condition is reached (Yes in step S2408), the model learning process is ended. Furthermore, if the end condition is not reached yet (No in step S2408), the processing returns to step S2401 to repeatedly execute the model learning process described above.

### INDUSTRIAL APPLICABILITY

The present disclosure has been described in detail with reference to the specific embodiment. However, it is obvious that those skilled in the art may make modifications and substitutions of the embodiment without departing from the gist of the present disclosure.

In the present specification, the embodiment in which the present disclosure is mainly mounted on the vehicle has been mainly described, but the gist of the present disclosure is not limited thereto. The present disclosure can also be mounted on various types of moving body apparatus other than the vehicle, such as a walking robot, a transport robot, and an unmanned aerial vehicle such as a drone, and can similarly perform object detection based on speed information obtained from a millimeter wave radar or the like. Furthermore, the present disclosure can be mounted on a multifunctional information terminal such as a smartphone or a tablet, a head-mounted display, a game machine, or the like, and can detect an object such as an obstacle on the front side of a user during walking.

In short, the present disclosure has been described in an illustrative manner, and the contents disclosed in the present specification should not be interpreted in a limited manner. In order to determine the gist of the present disclosure, the claims should be taken into consideration.

Note that the present disclosure can also have the following configurations.

(1) An information processing apparatus including:
a generation unit that generates a sensing image on the basis of sensor data including speed information of an object; and
a detection unit that detects the object from the sensing image using a learned model.

(2) The information processing apparatus according to (1), in which
the detection unit performs object detection using the learned model learned to recognize the object included in the sensing image.

(3) The information processing apparatus according to (1) or (2), in which
the generation unit projects sensor data including a three-dimensional point cloud onto a two-dimensional plane to generate the sensing image.

(4) The information processing apparatus according to (3), in which
the generation unit generates the sensing image having a pixel value corresponding to the speed information.

(5) The information processing apparatus according to (4), in which
the generation unit divides one sensing image into a plurality of sub-images on the basis of the pixel value, and
the detection unit inputs the plurality of sub-images to the learned model to detect the object.

(6) The information processing apparatus according to (5), in which
the detection unit inputs a time series of each of sub images divided from each of a plurality of consecutive sensing images to the learned model to detect the object.

(7) The information processing apparatus according to (5) or (6), in which
the detection unit performs object detection using the learned model learned to recognize the object from the plurality of sub-images obtained by dividing the sensing image on the basis of the pixel value.

(8) The information processing apparatus according to any one of (5) to (7), in which
the generation unit adds a texture corresponding to the speed information to each of the sub-images.

(9) The information processing apparatus according to any one of (1) to (8), in which
the learned model includes a DNN.

(10) The information processing apparatus according to any one of (1) to (9), in which
the sensor data is data captured by at least one sensor of a millimeter wave radar, a LiDAR, or a sound wave sensor.

(11) An information processing method including:
a generation step of generating a sensing image on the basis of sensor data including speed information of an object; and
a detection step of detecting the object from the sensing image using a learned model.

(12) A computer program written in a computer-readable format to cause a computer to function as:
a generation unit that generates a sensing image on the basis of sensor data including speed information of an object; and
a detection unit that detects the object from the sensing image using a learned model.

(13) A learning apparatus that performs learning of a model, the learning apparatus including:
an input unit that inputs a sensing image generated on the basis of sensor data including speed information of an object to the model; and
a model update unit that updates a model parameter of the model by performing error backpropagation to minimize a loss function based on an error between an output label and a correct answer label of the model with respect to the input sensing image.

(14) A learning method for performing learning of a model, the learning method including:
an input step of inputting a sensing image generated on the basis of sensor data including speed information of an object to the model;
a calculation step of calculating a loss function based on an error between an output label and a correct answer label of the model with respect to the input sensing image; and
a model update step of updating a model parameter of the model by performing error backpropagation to minimize the loss function.

(15) A computer program written in a computer-readable format to execute processing for performing learning of a model on a computer, the computer program causing the computer to function as:
an input unit that inputs a sensing image generated on the basis of sensor data including speed information of an object to the model; and
a model update unit that updates a model parameter of the model by performing error backpropagation to minimize a loss function based on an error between an output label and a correct answer label of the model with respect to the input sensing image.

(16) A learning apparatus that performs learning of a model, the learning apparatus including:
a recognition unit that recognizes a camera image; and
a model update unit that updates a model parameter of the model by performing error backpropagation to minimize a loss function based on an error between a recognition result by the model and recognition by the recognition unit with respect to a sensing image generated on the basis of sensor data including speed information of an object.

(17) The learning apparatus according to (16), in which
the sensor data is data captured by at least one sensor of a millimeter wave radar, a LiDAR, or a sound wave sensor mounted on the same device as the camera.

(18) A learning method for performing learning of a model, the learning method including:
a recognition step of recognizing a camera image; and
a model update step of updating a model parameter of the model by performing error backpropagation to minimize a loss function based on an error between a recognition result by the model and recognition in the recognition step with respect to a sensing image generated on the basis of sensor data including speed information of an object.

(19) A computer program written in a computer-readable format to execute processing for performing learning of a model on a computer, the computer program causing the computer to function as a learning apparatus including:
a recognition unit that recognizes a camera image; and
a model update unit that updates a model parameter of the model by performing error backpropagation to minimize a loss function based on an error between a recognition result by the model and recognition by the recognition unit with respect to a sensing image generated on the basis of sensor data including speed information of an object.

### REFERENCE SIGNS LIST

1 Vehicle
11 Vehicle control system
21 Vehicle control ECU
22 Communication unit
23 Map information accumulation unit
24 GNSS reception unit
25 External recognition sensor
26 In-vehicle sensor
27 Vehicle sensor
28 Hypochondrium
29 Travel assistance/automated driving control unit
30 DMS
31 HMI
32 Vehicle control unit
41 Communication network
51 Camera
52 Radar
53 LiDAR
54 Ultrasonic sensor
61 Analysis unit
62 Action planning unit
63 Operation control unit
71 Self-position estimation unit
72 Sensor fusion unit
73 Recognition unit
81 Steering control unit
82 Brake control unit
83 Drive control unit
84 Body system control unit
85 Light control unit
86 Horn control unit
300 Detection system
301 Generation unit
302 Detection unit
2100 Learning apparatus
2101 Learning data holding unit
2102 Model update unit
2103 Model parameter holding unit
2300 Learning apparatus
2301 Model update unit
2302 Model parameter holding unit

1. An information processing apparatus comprising:
a generation unit that generates a sensing image on a basis of sensor data including speed information of an object; and
a detection unit that detects the object from the sensing image using a learned model.

2. The information processing apparatus according to claim 1, wherein
the detection unit performs object detection using the learned model learned to recognize the object included in the sensing image.

3. The information processing apparatus according to claim 1, wherein
the generation unit projects sensor data including a three-dimensional point cloud onto a two-dimensional plane to generate the sensing image.

4. The information processing apparatus according to claim 3, wherein
the generation unit generates the sensing image having a pixel value corresponding to the speed information.

5. The information processing apparatus according to claim 4, wherein
the generation unit divides one sensing image into a plurality of sub-images on a basis of the pixel value, and
the detection unit inputs the plurality of sub-images to the learned model to detect the object.

6. The information processing apparatus according to claim 5, wherein
the detection unit inputs a time series of each of sub images divided from each of a plurality of consecutive sensing images to the learned model to detect the object.

7. The information processing apparatus according to claim 5, wherein
the detection unit performs object detection using the learned model learned to recognize the object from the plurality of sub-images obtained by dividing the sensing image on a basis of the pixel value.

8. The information processing apparatus according to claim 5, wherein
the generation unit adds a texture corresponding to the speed information to each of the sub-images.

9. The information processing apparatus according to claim 1, wherein
the learned model includes a DNN.

10. The information processing apparatus according to claim 1, wherein
the sensor data is data captured by at least one sensor of a millimeter wave radar, a LiDAR, or a sound wave sensor.

11. An information processing method comprising:
a generation step of generating a sensing image on a basis of sensor data including speed information of an object; and
a detection step of detecting the object from the sensing image using a learned model.

12. A computer program written in a computer-readable format to cause a computer to function as:
a generation unit that generates a sensing image on a basis of sensor data including speed information of an object; and
a detection unit that detects the object from the sensing image using a learned model.

13. A learning apparatus that performs learning of a model, the learning apparatus comprising:
an input unit that inputs a sensing image generated on a basis of sensor data including speed information of an object to the model; and
a model update unit that updates a model parameter of the model by performing error backpropagation to minimize a loss function based on an error between an output label and a correct answer label of the model with respect to the input sensing image.

14. A learning method for performing learning of a model, the learning method comprising:
an input step of inputting a sensing image generated on a basis of sensor data including speed information of an object to the model;
a calculation step of calculating a loss function based on an error between an output label and a correct answer label of the model with respect to the input sensing image; and
a model update step of updating a model parameter of the model by performing error backpropagation to minimize the loss function.

15. A computer program written in a computer-readable format to execute processing for performing learning of a model on a computer, the computer program causing the computer to function as:
an input unit that inputs a sensing image generated on a basis of sensor data including speed information of an object to the model; and
a model update unit that updates a model parameter of the model by performing error backpropagation to minimize a loss function based on an error between an output label and a correct answer label of the model with respect to the input sensing image.

16. A learning apparatus that performs learning of a model, the learning apparatus comprising:
a recognition unit that recognizes a camera image; and
a model update unit that updates a model parameter of the model by performing error backpropagation to minimize a loss function based on an error between a recognition result by the model and recognition by the recognition unit with respect to a sensing image generated on a basis of sensor data including speed information of an object.

17. The learning apparatus according to claim 16, wherein
the sensor data is data captured by at least one sensor of a millimeter wave radar, a LiDAR, or a sound wave sensor mounted on a same device as the camera.

18. A learning method for performing learning of a model, the learning method comprising:
a recognition step of recognizing a camera image; and
a model update step of updating a model parameter of the model by performing error backpropagation to minimize a loss function based on an error between a recognition result by the model and recognition in the recognition step with respect to a sensing image generated on a basis of sensor data including speed information of an object.

19. A computer program written in a computer-readable format to execute processing for performing learning of a model on a computer, the computer program causing the computer to function as a learning apparatus including:
a recognition unit that recognizes a camera image; and
a model update unit that updates a model parameter of the model by performing error backpropagation to minimize a loss function based on an error between a recognition result by the model and recognition by the recognition unit with respect to a sensing image generated on a basis of sensor data including speed information of an object.
